(19) United States
(12) Patent Application Publication
(10) Pub. No.: US 2016/0302641 A1
(43) Pub. Date: Oct. 20, 2016

(54) KNIFE WASHING STATION AND HANDHELD KNIFE CLEANER

(71) Applicants: Laura Lisa Ivy, Los Altos, CA (US); Adrian Gutierrez, San Jose, CA (US); Yugen Patrick Lockhart, Palo Alto, CA (US); Ronald L. Johnson, San Jose, CA (US); Steven Escobar, San Jose, CA (US)

(72) Inventors: Laura Lisa Ivy, Los Altos, CA (US); Adrian Gutierrez, San Jose, CA (US); Yugen Patrick Lockhart, Palo Alto, CA (US); Ronald L. Johnson, San Jose, CA (US); Steven Escobar, San Jose, CA (US)

(21) Appl. No.: 15/133,611

(22) Filed: Apr. 20, 2016

Related U.S. Application Data
(60) Provisional application No. 62/149,977, filed on Apr. 20, 2015.

(51) Int. Cl. A47L 15/37; B08B 1/00; A47L 17/00

(52) U.S. Cl. CPC A47L 15/37; A47L 17/00; B08B 1/006

(57) ABSTRACT

A knife cleaning station comprises a soaking station, a scrubbing unit, and a drying unit. Each station comprises its own chamber. The interior of the body and each station is able to be removed for cleaning, customization, and repair. In some embodiments, the cleaning station comprises more or less stations as appropriately desired. A handheld knife cleaner comprises a frame with one or more brush pads, and a palm protector. In some embodiments, a finger guide allows grip and stability when a knife is being cleaned. The one or more brush pads are able to be interchanged for a variety of different tasks.

### RELATED APPLICATIONS

This application claims priority of U.S. provisional application, Ser. No. 62/149,977, filed Apr. 20, 2015, and entitled “KITCHEN WISE,” which is incorporated herein by reference.

### FIELD OF THE INVENTION

The present invention is generally directed to knife cleaning apparatuses. More specifically, the present invention is directed to a knife cleaning station and handheld knife cleaner.

### BACKGROUND OF THE INVENTION

Without proper cleaning, a knife can become rusted, corroded and dull and lose its proper function over time. However, because the knife blade is sharp, cleaning the knife can be difficult. For proper function of the knife, it must be soaked, scrubbed and dried while ensuring that the blade remains sharp and without cutting the user.

### SUMMARY OF THE INVENTION

A knife cleaning station comprises a soaking station, a scrubbing unit, and a drying unit.

Each station comprises its own chamber. The interior of the body and each station is able to be removed for cleaning, customization, and repair. In some embodiments, the cleaning station comprises more or less stations as appropriately desired. A handheld knife cleaner comprises a frame with one or more brush pads, and a palm protector. In some embodiments, a finger guide allows grip and stability when a knife is being cleaned. The one or more brush pads are able to be interchanged for a variety of different tasks.

In one aspect, a knife cleaning station comprises a cleaning station body comprising a soaking station for soaking one or more knives, a scrubbing unit for scrubbing the one or more knives, and a drying unit for drying the one or more knives, wherein the soaking station, the scrubbing unit, and the drying unit fit within an interior of the cleaning station body. In some embodiments, the soaking station, the scrubbing unit, and the drying unit are removable from the cleaning station body. The soaking station can comprise one or more knife holder clips that hold a handle of the knife above the waterline while the knife is in the soaking station. In some embodiments, the soaking station comprises one or more stabilizing features for securely holding the one or more knives in a vertical orientation. Particularly, the soaking station is configured to accept a plurality of knives of different sizes. The scrubbing unit comprises one or more scrubbing pads. In some embodiments, the one or more scrubbing pads comprise one or more of a sponge and a bristle pad. In some embodiments, the scrubbing unit is configured to accept one or both of a ceramic knife blade and a serrated knife blade. The drying unit can comprise one or more water absorbent pads. The drying unit is configured to hold the knife blade in one of a vertical orientation and a horizontal orientation. In some embodiments, the drying unit comprises one or more knife guards for preventing damage to the knife cleaning station.

In another aspect, a knife cleaning station comprises a cleaning station body comprising a first cleaning unit comprising a first function and a second cleaning unit comprising a second function different from the first function, wherein the first cleaning unit fit within an interior of the cleaning station body. In some embodiments, the first cleaning unit and the second cleaning unit each comprise one of a soaking unit, a scrubbing unit, and a drying unit.

In a further aspect, a handheld knife cleaner comprises an outer frame comprising a first side and a second side one or more brush pads coupled to an interior of the outer frame and a palm protector between the first side and the second side and on the interior frame, wherein the handheld knife cleaner is bendable at the palm protector so that the first side and the second side face each other. In some embodiments, the outer frame comprises a plurality of hinges. In some embodiments, the plurality of brush pads are replaceable. Particularly, the interior frame comprises one or more fasteners for locking the plurality to the brush pads to the interior frame. In some embodiments, the one or more brush pads snap fit to the interior of the outer frame. The one or more of brush pads can comprise one of a sponge material and a scouring material. In some embodiments, the hand held knife cleaner comprises one or more finger protector features coupled to the outer frame. In some embodiments, the handheld knife cleaner comprises a plurality of brush pads. The plurality of brush pads can comprise different bristle patterns.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIGS. 1A and 1B illustrate an exploded view of a knife cleaning station, in accordance with some embodiments.

FIG. 2 illustrates an interior body of a knife cleaning station, in accordance with some embodiments.

FIG. 3 illustrates a knife soaking unit of a knife cleaning station, in accordance with some embodiments.

FIG. 4 illustrates a knife scrubbing unit of a knife cleaning station, in accordance with some embodiments.

FIG. 5 illustrates a knife drying unit of a knife cleaning station, in accordance with some embodiments.

FIGS. 6A and 6B illustrate a handheld knife cleaner, in accordance with some embodiments.

FIG. 7 illustrates a handheld knife cleaner, in accordance with some embodiments.

FIG. 8A illustrates a handheld knife cleaner in a closed position, in accordance with some embodiments.

FIG. 8B illustrates a handheld knife cleaner in an open position, in accordance with some embodiments.

FIG. 9 illustrates a handheld knife cleaner in use, in accordance with some embodiments.

### DETAILED DESCRIPTION OF THE EMBODIMENTS

Embodiments of the invention are directed to a knife cleaning station and handheld knife cleaner. A knife cleaning station comprising a soaking unit, a scrubbing unit, and a drying unit. Each station comprises its own chamber. The interior of the body and each station is able to be removed for cleaning, customization, and repair. In some embodiments, the cleaning station comprises more or less stations as appropriately desired. A handheld knife cleaner comprises a frame with one or more brush pads, a palm protector and one or more guides that ensure that the knife stays within the palm protector. In some embodiments, a finger guide allows grip and stability when a knife is being cleaned. The one or more brush pads can be interchanged for a variety of different tasks.

Reference will now be made in detail to implementations of a knife cleaning station and handheld knife cleaner as illustrated in the accompanying drawings. The same reference indicators will be used throughout the drawings and the following detailed description to refer to the same or like parts. In the interest of clarity, not all of the routine features of the implementations described herein are shown and described. It will be appreciated that in the development of any such actual implementation, numerous implementation-specific decisions can be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

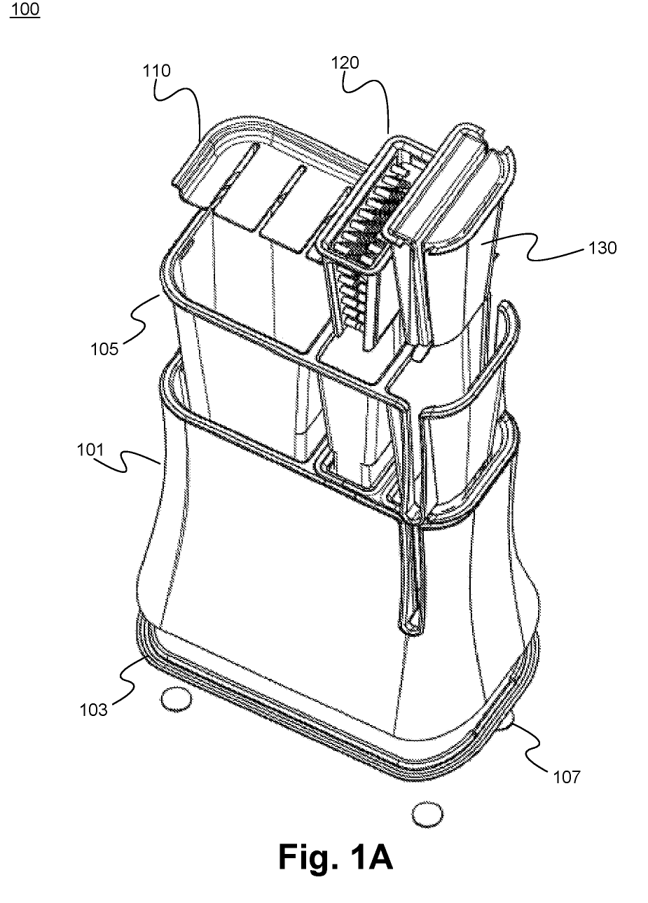

Referring now to FIGS. 1A and 1B, an exploded view of a knife cleaning station 100 is depicted therein. The knife cleaning station 100 comprises an exterior cleaning station body 101, a base 103 coupled to the exterior body 101, and an interior body 105. The interior body 105 is configured to couple with and fit into the exterior body 101. The knife cleaning station 100 also comprises a soaking unit 110 for soaking one or more knives during cleaning, a scrubbing unit 120 for scrubbing the one or more knives, and a drying unit 130 for drying the one or more knives. The soaking unit 110, the scrubbing unit 120, and the drying unit 130 are configured to fit within the interior body 105 and the exterior body 101. In some embodiments, the soaking unit 110 comprises one or more knife holder clips 111, the scrubbing unit 120 comprises one or more scrubbing pads 121, and the drying unit 130 comprises one or more water absorbent pads 131. The components of the knife cleaning station 100 are removable from the exterior body 101 for washing and/or are replaceable. As shown within FIGS. 1A and 1B, in some embodiments, the knife cleaning station 100 also comprises one or more non-slip feet 107 for securing the knife station 100 on a counter or other cleaning area.

The knife cleaning station 100 comprises three major functions: soaking within the soaking unit 110, scrubbing within the scrubbing unit 120, and drying within the drying unit 130.

The interior body 105, as well as the soaking unit 110, the scrubbing unit 120, and the drying unit 130 are removable for cleaning, customization, and for repair. In some embodiments, the knife cleaning station 100 comprises more or less stations as appropriately desired.

The base 103 of the cleaning station 100 seals the bottom of the cleaning station 100 from any leak from the soaking unit 110, the scrubbing unit 120, and the drying unit 130. The one or more non-slip feet 107 keep the knife cleaning station 100 from sliding or accidentally moving when on wet or dry surfaces. The non-slip feet 107 also protect the cleaning station 100 from being scratched by and scratching on a resting surface. In some embodiments, the base 103 is removable and can be replaced with bases specifically designed for suction mounting and elevating mounting. In some embodiments, the base 103 is customizable in appearance with different colors, materials, and finishes.

As further shown within FIGS. 1A and 1B, in some embodiments, the exterior body 101 comprises an hourglass shape. The hourglass shape aids in ergonomics by naturally making the narrow portion easy to grip and handle. Since the width of the exterior body 101 grows further from the center it creates a natural grip without needing additional material. Additionally, the hourglass shape creates a wide footprint at the base of the body 101 so that the cleaning station 100 is additionally stable. Further, because of the height and weight of the exterior body 101, the wide foot print enables the cleaning station 100 to be more stable while under load and in use. Moreover, the hourglass silhouette is recognizable from any horizontal angle. The two narrower sides of the exterior body 101 also have defined hard edges for a unique and signature tactile interaction.

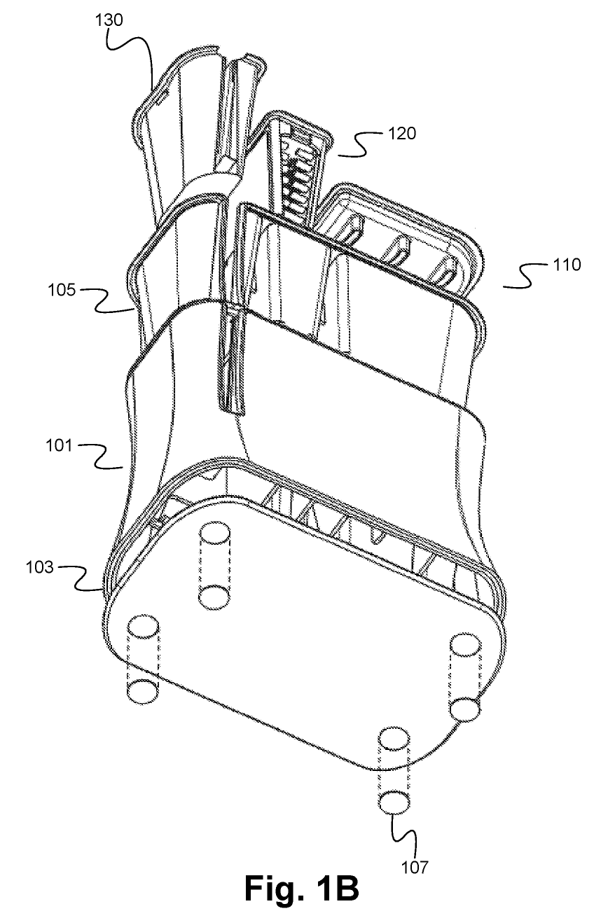

FIG. 2 illustrates the interior body 105 comprising the soaking unit 110, the scrubbing unit 120, and the drying unit 130. As shown within FIG. 2, and as described above, the soaking unit 110 comprises one or more knife holder clips 111, the scrubbing unit 120 comprises one or more scrubbing pads 121, and the drying unit 130 comprises one or more water absorbent pads 131. As further shown in FIG. 2, in some embodiments, the drying unit 130 comprises a knife guard 133 for preventing damage to the cleaning station 100 as a knife is placed within the drying unit 130.

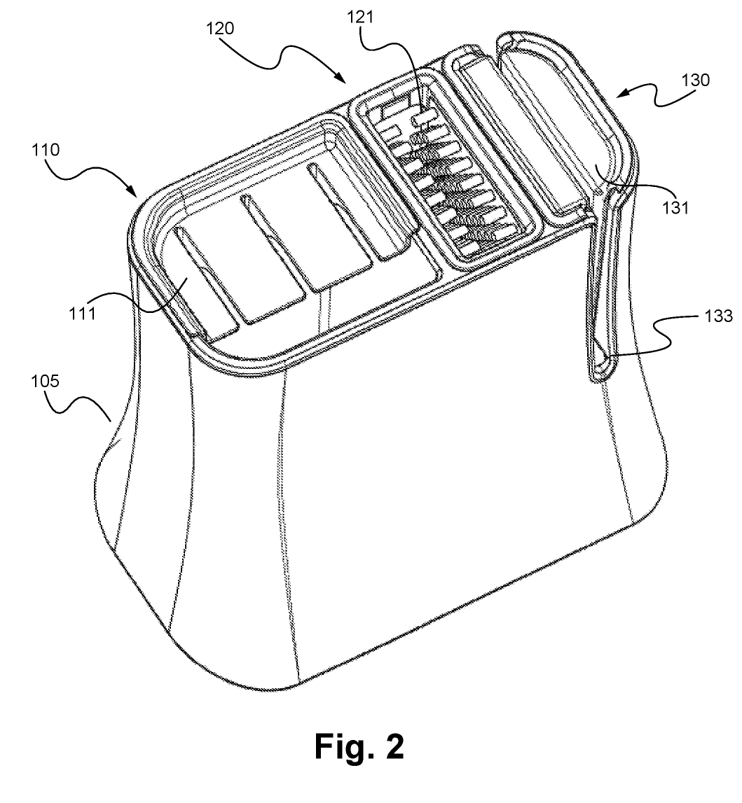

FIG. 3 illustrates a knife 115 that is being soaked within the soaking unit 110. The soaking unit 110 is configured to loosen debris from a knife as the knife blade is submerged within hot soapy water held within the soaking unit 110. As shown within FIG. 3, the knife 115 is held by a knife holder clip 111. The knife holder clip 111 is configured to hold the knife 115 so that the knife blade soaks while a handle of the knife remains above the water line. In some embodiments, the soaking unit 110 is configured to accept a plurality of knives of different sizes. The soaking unit 110 and the knife holder clip 111 are configured to accept and hold a knife in a vertical orientation. In some embodiments, the soaking unit 110 comprises multiple knife stabilizing features that keep the knife 115 in the vertical orientation and from contacting one or more additional knives that can be soaking in the soaking unit 110 at the same time. The knife stabilizer can keep the knives from rocking in a front-to-back and a side-to-side direction while within the soaking unit 110. As will be apparent to someone of ordinary skill in the art, the soaking unit 110 can hold any desired number of knives. The soaking unit 110 is modular and customizable.

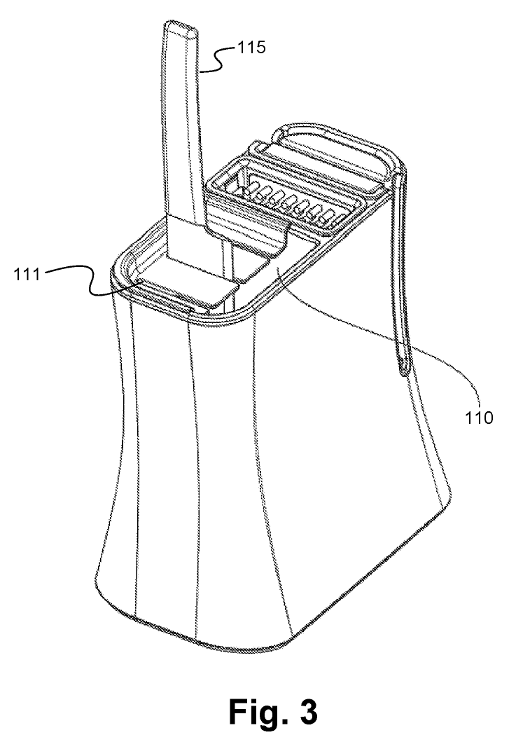

FIG. 4 illustrates a knife 115 that is being scrubbed within the scrubbing unit 120. As described above, in some embodiments, the scrubbing unit 120 comprises one or more scrubbing pads 121. In some embodiments, the one or more scrubbing pads 121 comprise dual action bristles. The scrubbing unit 120 comprises multiple bristles to ensure sufficient coverage on the knife blade. The scrubbing unit 120 is modular and customizable. The scrubbing unit 120 can comprise multiple large and small knife holders, multiple bristle units, a sponge unit, and/or a combination of bristle and sponge units. The scrubbing unit 120 can be configured to accept one or both of a ceramic knife blade and a serrated knife blade.

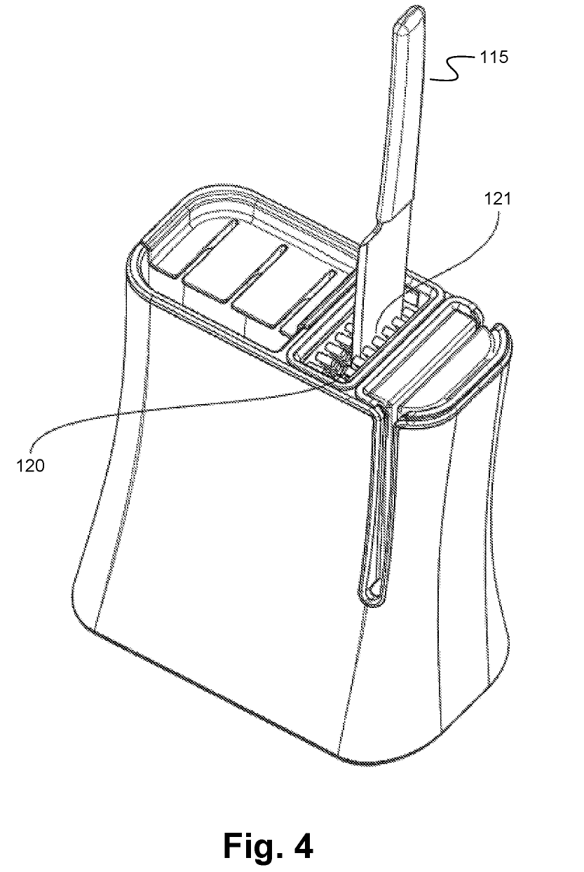

FIG. 5 illustrates a knife 115 that is being held within the drying unit 130 for drying. As described above, and as shown within FIG. 5, the drying unit 130 comprises one or more water absorbent pads 131. The one or more water absorbent pads 142 are configured to dry the knife 115 for storage. The drying unit 130 can hold a knife 115 in the one of a vertical orientation and a horizontal orientation. As described above, in some embodiments, the drying unit 130 comprises a knife guard 133 within a bottom of the drying unit 130 that ensures that while the knife 115 can be drawn in the drying unit 130, the knife guard 133 prevents the cleaning station 100 from being damaged if too much pressure is placed on the knife 115 causing it to slip through the one or more water absorbent pads 131. In some embodiments, the one or more water absorbent pads 131 are placed at opposing angles so that the further down a wet knife 115 travels through the pads 131, the more pressure that is applied from the sides as the one or more pads 131 are pushed closer together. In some embodiments, the drying unit 130 and the one or more water absorbent pads 131 are removable from the cleaning station 100 for cleaning and for replacing the pads 131. Particularly, the drying unit 130 can be replaced with and/or configured with appropriately desired sizes and configuration of pads 131. In some embodiments, the drying unit 130 and/or the cleaning station comprises and integrated and/or stand-alone knife sharpening station.

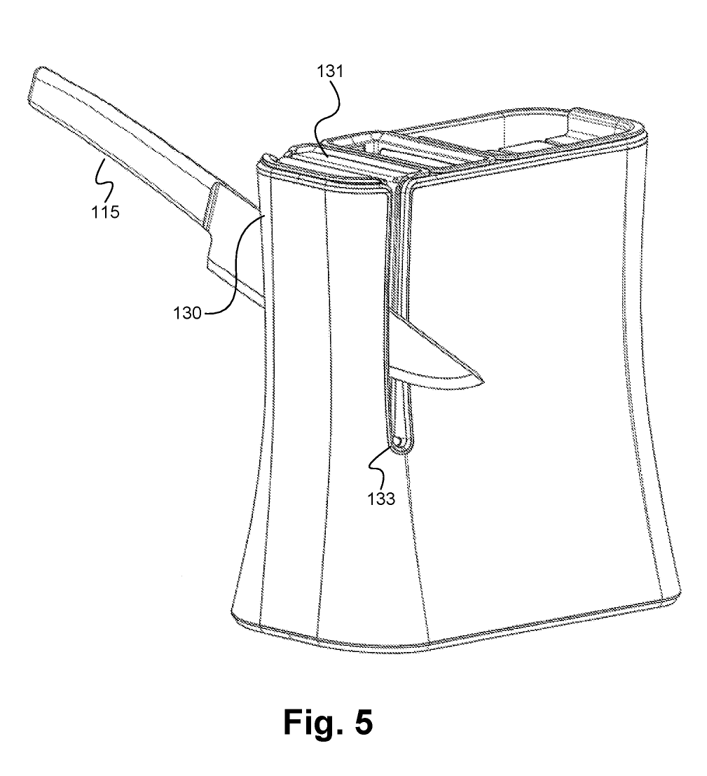

FIGS. 6A and 6B illustrate a handheld knife cleaner 200 in accordance with further embodiments. The handheld knife cleaner 200 comprises an outer frame 201 comprising a first side 220 and a second side 230, a plurality of brush pads 220 coupled to an interior of the outer frame 201, and a palm protector 210 located between the plurality of brush pads 220 on the interior of the outer frame 201. In some embodiments, the handheld knife cleaner 200 comprises a plurality of hinges 211 and 212 for folding the knife cleaner 200 so that the first side 220, the second side 230 and the plurality of brush pads 220 face each other. In some embodiments, the plurality of brush pads 220 are replaceable. For example, in some embodiments, one or more male snaps 225 of the brush pads 220 are configured to couple with one or more female snaps 205 of the interior side of the outer frame 201. In some embodiments, a finger protector 203 on the outer framer 201 can protect the fingers of a user as the handheld knife cleaner 200 is used to clean a knife.

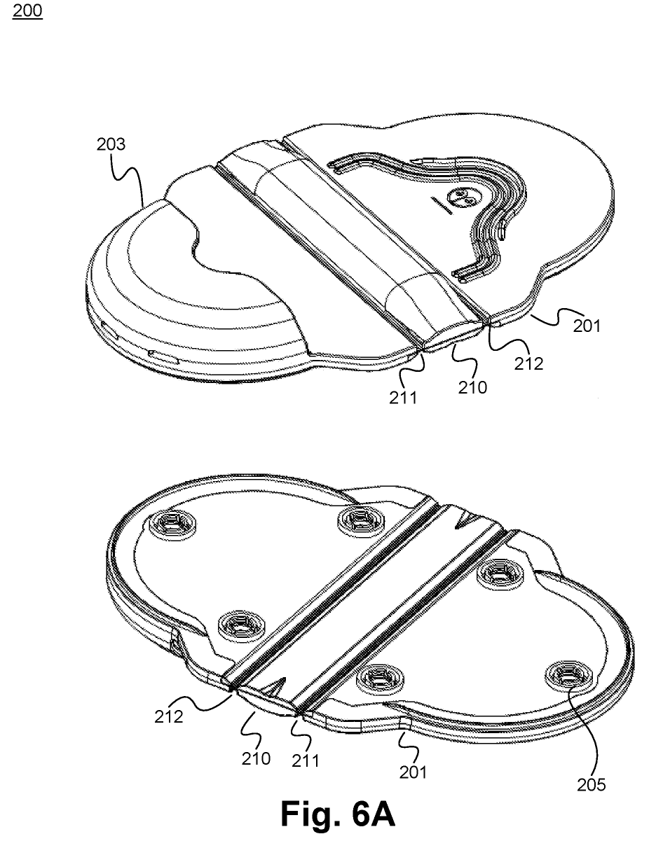

FIG. 7 illustrates the handheld knife cleaner 200 with the plurality of brush pads 220 coupled to an interior of the outer frame 201. In some embodiments, such as shown within FIG. 7, the plurality of brush pads comprise one of a sponge material 222 and 223 and a scouring material 224. However, as will be apparent to someone of ordinary skill in the art, the plurality of brush pads 220 can comprise any appropriately desired cleaning material. For example, in some embodiments, the plurality of brush pads 220 comprise one or more different bristle patterns.

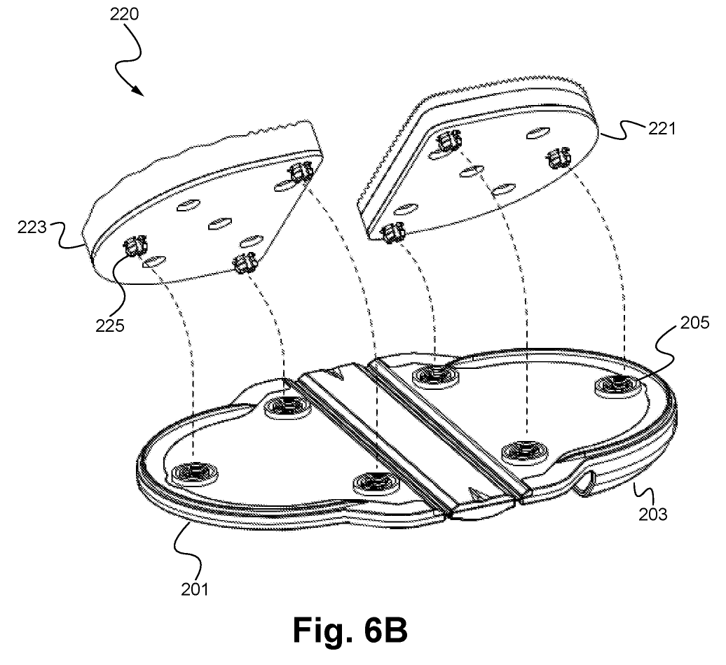

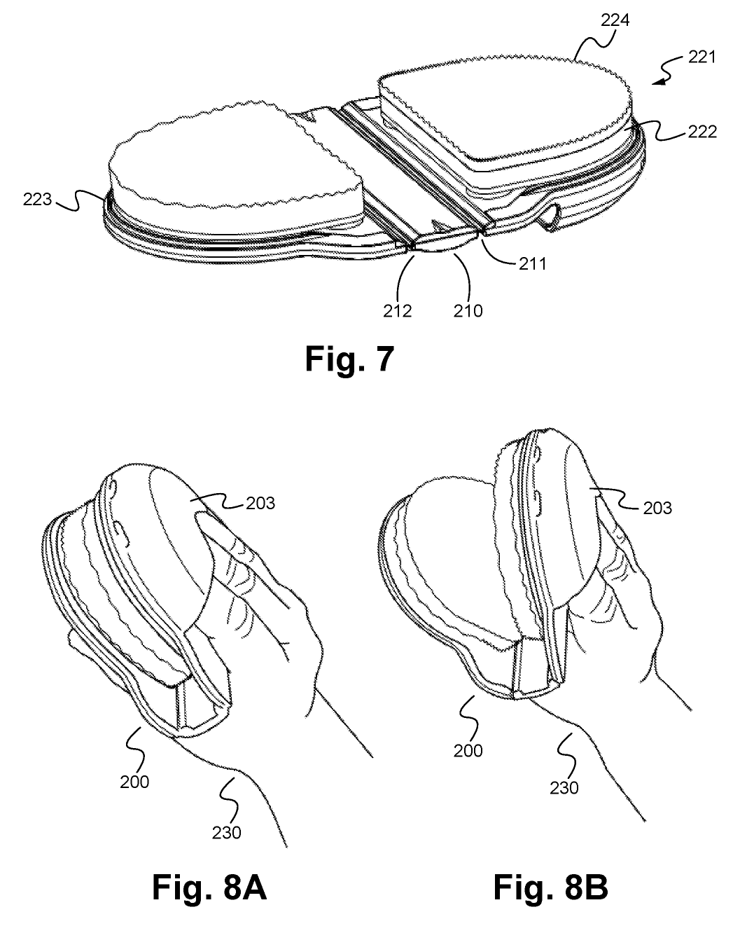

FIG. 8A illustrate a hand held knife cleaner 200 in a closed position in accordance with some embodiments. As shown within FIG. 8A, a hand 230 can grip the knife cleaner 200 with one or more fingers inserted into the finger protector 203 to close the knife cleaner 200. In the closed position, the plurality of brush pads 220 face each and can squeeze a knife and to clean the knife. FIG. 8B illustrates the handheld knife cleaner 200 in the open position and configured to accept and clean a knife

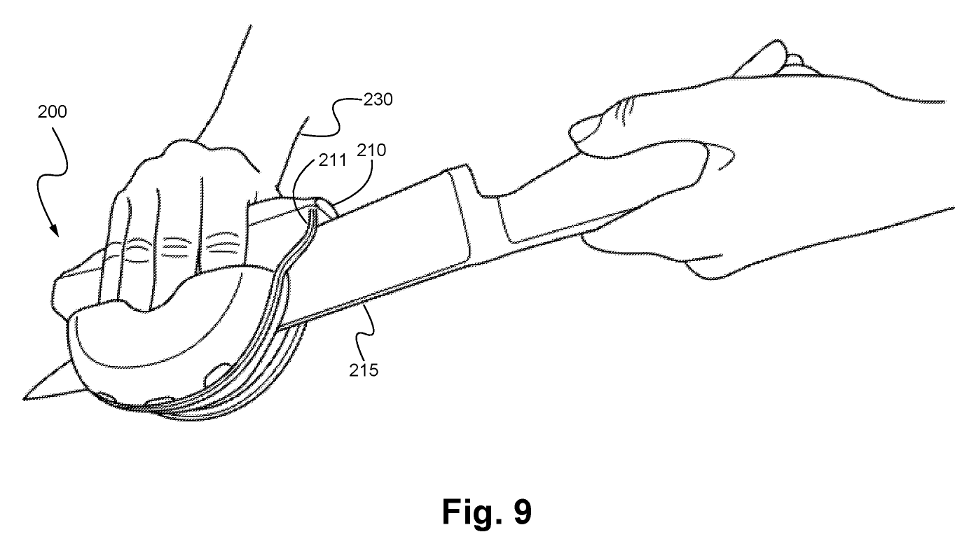

As shown within FIG. 9, in the cleaning position, the handheld knife cleaner 200 is closed around a knife 215 and bent around the hinges 211 and 212. In this position, the plurality of brush pads 220 can scrub the knife blade while the palm protector 210 protects a user's palm from the edge of knife blade.

The handheld knife cleaner 200 is a modular system that can wipe, scrub and dry a knife with a variety of interchangeable pads 220. The body consists of an outer frame 201 comprising a cut resistant material that ensures that a user is not cut while using the knife cleaner 200. The finger protector 203 keeps fingers in a safe location, behind the cut resistant outer frame 201 an aids in grip when hands get wet and slick when cleaning a knife with soapy water. Additionally, the palm protector 210 protects the user's palm from the knife blade while allowing the user to aggressively clean the knife blade.

The interchangeable pads 220 can be removed and replaced with a variety of pads for multiple functions. For example, ins some embodiments the interchangeable pads 220 can comprise drying, scrubbing, and wiping pads with bristles, sponges, and absorbing pads Additionally, the pads 200 can comprise multiple bristle patterns and with varying stiffness, sponge type and absorption. Additionally, the brush pads 220 are securely coupled to the outer frame 201 and free from dislodging until it is desired to remove the brush pads 220.

In operation, a knife cleaning station comprises a soaking unit, a scrubbing unit, and a drying unit. Each station comprises its own chamber. The interior of the body and each station are able to be removed for cleaning, customization, and repair. In some embodiments, the cleaning station comprises more or less stations as appropriately desired. A handheld knife cleaner comprises a frame with one or more brush pads, and a palm protector. In some embodiments, a finger guide allows grip and stability when a knife is being cleaned. The one or more brush pads are able to be interchanged for a variety of different tasks. Particularly, the knife cleaning station and the handheld knife cleaner enable a user to safely and thoroughly clean a knife an knife blade. Accordingly, the knife cleaning station and handheld knife cleaner as described herein has many advantages.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A knife cleaning station comprising:
a. a cleaning station body comprising:
i. a soaking unit for soaking one or more knives;
ii. a scrubbing unit for scrubbing the one or more knives; and
iii. a drying unit for drying the one or more knives,
wherein the soaking unit, the scrubbing unit, and the drying unit fit within an interior of the cleaning station body.

2. The knife cleaning station of claim 1, wherein the soaking unit, the scrubbing unit, and the drying unit are removable from the cleaning station body.

3. The knife cleaning station of claim 1, wherein the soaking unit comprises one or more knife holder clips that hold a handle of the knife above the waterline while the knife is in the soaking unit.

4. The knife cleaning station of claim 1, wherein the soaking unit comprises one or more stabilizing features for securely holding the one or more knives in a vertical orientation.

5. The knife cleaning station of claim 1, wherein the soaking unit is configured to accept a plurality of knives of different sizes.

6. The knife cleaning station of claim 1, wherein the scrubbing unit comprises one or more scrubbing pads.

7. The knife cleaning station of claim 7, wherein the one or more scrubbing pads comprise one or more of a sponge and a bristle pad.

8. The knife cleaning station of claim 1, wherein the scrubbing unit is configured to accept one or both of a ceramic knife blade and a serrated knife blade.

9. The knife cleaning station of claim 1, wherein the drying unit comprises one or more water absorbent pads.

10. The knife cleaning station of claim 1, wherein the drying unit is configured to hold the knife blade in one of a vertical orientation and a horizontal orientation.

11. The knife cleaning station of claim 1, wherein the drying unit comprises one or more knife guards for preventing damage to the knife cleaning station.

12. A knife cleaning station comprising:
a. a cleaning station body comprising:
i. a first cleaning unit comprising a first function; and
ii. a second cleaning unit comprising a second function different from the first function,
wherein the first cleaning unit fits within an interior of the cleaning station body.

13. The knife cleaning station of claim 12, wherein the first cleaning unit and the second cleaning unit each comprise one of a soaking unit, a scrubbing unit, and a drying unit.

14. A handheld knife cleaner comprising:
a. an outer frame comprising a first side and a second side;
b. one or more brush pads coupled to an interior of the outer frame; and
c. a palm protector between the first side and the second side and on the interior frame,
wherein the handheld knife cleaner is bendable at the palm protector so that the first side and the second side face each other.

15. The handheld knife cleaner of claim 14, wherein the outer frame comprises a plurality of hinges.

16. The handheld knife cleaner of claim 14, wherein the one or more brush pads are replaceable.

17. The handheld knife cleaner of claim 16, wherein the interior frame comprises one or more fasteners for locking the plurality to the brush pads to the interior frame.

18. The handheld knife cleaner of claim 16, wherein the one or more pads snap fit to the interior of the outer frame.

19. The handheld knife cleaner of claim 14, wherein the one or more brush pads comprise a sponge material.

20. The handheld knife cleaner of claim 14, wherein the one or more brush pads comprise a scouring material.

21. The handheld knife cleaner of claim 14, wherein the one or more brush pads comprise a brush material.

22. The handheld knife cleaner of claim 14, comprising one or more finger protector features coupled to the outer frame.

23. The handheld knife cleaner of claim 14, comprising a plurality of brush pads.

24. The handheld knife cleaner of claim 23, wherein the plurality of brush pads comprise different bristle patterns.
